(19) United States
(12) Patent Application Publication
(10) Pub. No.: US 2015/0344281 A1
(43) Pub. Date: Dec. 3, 2015

(54) WATER DISPENSER

(71) Applicant: KABUSHIKI KAISHA COSMO LIFE, Hyogo (JP)

(72) Inventor: Yoshinori ORITA, Hyogo (JP)

(21) Appl. No.: 14/759,669

(22) PCT Filed: Nov. 28, 2013
(86) PCT No.: PCT/JP2013/082029

§ 371 Date: Jul. 8, 2015

(30) Foreign Application Priority Data
Mar. 1, 2013 (JP) 2013-040490

(51) Int. Cl. B67D 1/00; B67D 1/08

(52) U.S. Cl. CPC B67D 1/0004; B67D 1/0891

(57) ABSTRACT

A water dispenser is provided which includes a replaceable raw water container, a container mounting table onto which the raw water container is placed, and a raw water pumping pipe configured to be connected to a water outlet port of the raw water container; wherein a container holder configured to hold the raw water container with a neck portion thereof directed horizontally is formed in the shape of a box having handles and placed detachably on the container mounting table. With this arrangement, when the raw water container is replaced, the container holder can be lifted up with the raw water container received therein by holding the handles of the container holder and placed on the container mounting table. Therefore, it is not necessary to lift up the raw water container by itself, and the operational efficiency in the replacement of the raw water container can be improved.

### TECHNICAL FIELD

The present invention relates to a water dispenser which supplies drinking water from a replaceable raw water container filled with drinking water such as mineral water.

### BACKGROUND ART

Conventionally, water dispensers have been used primarily in offices and in hospitals. With a growing interest in water safety and health in recent years, however, water dispensers are gaining popularity among ordinary households. A well-known example of such water dispensers is one in which a replaceable raw water container is placed on the upper surface of a housing, so that drinking water filled in the raw water container falls down to a cold water tank housed in the housing with gravity (such as one disclosed in the below-identified Patent Document 1).

The raw water container of the above mentioned water dispenser includes a hollow cylindrical trunk portion, a bottom portion provided at one end of the trunk portion, and a neck portion provided at the other end of the trunk portion through a shoulder portion; wherein the neck portion is provided with a water outlet port. This raw water container is set to the water dispenser with the neck portion of the raw water container facing downward such that the water outlet port is placed at the lowermost position of the water bottle.

Since, in the water dispenser disclosed in Patent Document 1, the raw water container is set on the upper surface of the housing, a fully filled raw water container needs to be lifted high when replacing the raw water container. However, the fully filled raw water container usually contains drinking water of about 10 to 12 liters, weighing 10 kg or more, and the replacement of the raw water container was a tough task for water dispenser users (for women and the elderly, in particular).

Therefore, the present inventors have developed a type of water dispenser in which the raw water container is placed at the lower portion of the housing. As shown in FIG. 9, in this water dispenser, a container holder 83 configured to hold a raw water container 81 in a position lying on its side (in other words, in a position in which a neck portion 82 of the raw water container 81 is directed horizontally) is supported horizontally slidably by slide rails 85 provided on a bottom plate 84a of a housing 84; an end portion (joint portion) 86a of a raw water pumping pipe 86 which allows communication between the raw water container 81 and a cold water tank (not shown) provided at the upper portion of the housing 84 is fixed inside the housing 84; a water outlet port 87 of the raw water container 81 is configured to be connected to the end portion 86a of the raw water pumping pipe 86 by the sliding operation of the container holder 83; and a pump (not shown) provided in the raw water pumping pipe 86 is configured to pump out drinking water from the raw water container 81.

### PRIOR ART DOCUMENT(S)

### Patent Document(s)

Patent Document 1: JP 2012-162318 A

### SUMMARY OF THE INVENTION

### Problems to be Solved by the Invention

If the raw water container of the water dispenser is placed at the lower portion of the housing, as described above, the workload for replacing the raw water container in this water dispenser is significantly reduced compared to that in the conventional water dispenser in which the raw water container is placed at the upper surface of the housing.

However, in the water dispenser shown in FIG. 9, the container holder 83 supporting the raw water container 81 in a position lying on its side is formed in the shape of a box which opens upward, and is fixed to the sliding portions of the slide rails 85. Therefore, when the raw water container 81 is replaced, it is necessary to pull out the container holder 83 out of the housing 84, remove the used up raw water container 81, and then lift up a fully filled raw water container 81 for about several tens of centimeters, to set the raw water container 81 into the container holder 83 from above the container holder 83. Thus, there was a room for further improvement, in terms of operational efficiency.

In order to solve the above mentioned problems, it is possible to provide a handle to the trunk portion of the raw water container so that the raw water container can be lifted up in a position lying on its side. However, raw water containers are usually disposable, and it is not practical, in terms of cost, to provide a firm handle which allows a raw water container to be lifted up easily to the trunk portion of the raw water container. The cost for providing a handle can be reduced, on the other hand, if the handle is formed using a piece of a low cost tape by fixing the both ends thereof to the trunk portion of the raw water container. However, when a user lifts up the raw water container by holding the handle, the user could have a concern lest the tape could be broken, or could feel pain due to the tape biting into his/her hand.

### Means for Solving the Problems

Accordingly, an object of the present invention is to provide a water dispenser in which the raw water container is placed in a position lying on its side, wherein the operational efficiency in the replacement of the raw water container is improved, without increasing the cost of the raw water container itself.

In order to solve the above mentioned problems, the present invention has adopted the following constitution.

A water dispenser comprising:

a replaceable raw water container comprising: a hollow cylindrical trunk portion; a bottom portion provided at one end of the trunk portion; and a neck portion provided at the other end of the trunk portion through a shoulder portion; wherein the neck portion is provided with a water outlet port;

a container mounting table configured such that the raw water container can be placed on the container mounting table; and

a raw water pumping pipe configured to be connected to the water outlet port of the raw water container;

wherein a container holder which is formed in the shape of a box having handles and configured to hold the raw water container with the neck portion thereof directed horizontally is placed detachably on the container mounting table.

According to the above mentioned constitution, the raw water container can be set to the water dispenser by: removing the container holder from the container mounting table; stowing the raw water container inside the container holder by placing the container holder so as to cover the raw water container which is placed close to the position at which the water dispenser is disposed; lifting up the container holder by holding the handles of the container holder with the raw water container received therein, and by placing the container holder on the container mounting table such that the neck portion the raw water container is directed horizontally. Thus, the raw water container can be set to the water dispenser easily in a position lying on its side, without lifting up the raw water container by itself, which is heavy and hard to carry. Further, since there is no need to provide a handle to the raw water container, the cost of the raw water container itself is not increased.

As the above mentioned container holder, it is possible to use one that opens upward to form an opening through which the raw water container can be placed into and taken out of the container holder.

In addition, in the above mentioned water dispenser, if a plurality of protruded portions are provided on the surface of the container holder which comes into contact with the container mounting table, and the container mounting table is provided with fitting portions into which the protruded portions are inserted, the position of the container holder holding the raw water container therein can be easily fixed on the container mounting table when the container holder is placed thereon, and the connection between the water outlet port of the raw water container and the raw water pumping pipe can be facilitated. This serves to further improve the operational efficiency in the replacement of the raw water container. In the water dispenser having the above mentioned constitutions, it is preferred that the protruded portions provided on the container holder be formed in the shape of a cone or a hemisphere, because the fixing of the position of the container holder on the container mounting table can be more smoothly performed, when the container holder is placed thereon.

If a neck supporting portion configured to support the neck portion of the raw water container is provided at the peripheral wall of the container holder, the water outlet port of the raw water container can be securely connected to the raw water pumping pipe. In the water dispenser having the above mentioned constitutions, the neck supporting portion of the container holder can be formed in the shape of a trough protruding outwardly from the peripheral wall of the container holder and configured to be fitted to the lower side of the neck portion of the raw water container.

When the neck supporting portion is formed in the shape of a trough, as described above, it is preferred that a pair of flanges be provided on the outer periphery of the neck portion of the raw water container, and a projecting piece configured to engage with the pair of flanges be provided on the upper surface of the neck supporting portion of the container holder, so that the position of the raw water container relative to that of the container holder in the forward and rearward direction (in the axial direction of the neck portion) can be securely fixed. Further, if a rib is provided on the upper surface of the neck supporting portion of the container holder on the side of the proximal end of the neck supporting portion to extend to the vicinity of the proximal end, such that a space is defined between the rib and the projecting piece, into which space only one of the flanges of the raw water container can be inserted, it is possible to prevent a situation in which the water outlet port of the raw water container is not properly connected to the raw water pumping pipe, due to the neck portion of the raw water container being fitted to the neck supporting portion with both of the pair of flanges of the raw water container coming to positions closer to the proximal end of the container holder than that of the projecting piece.

### Effect of the Invention

In the water dispenser according to the present invention, the container holder which is configured to hold the raw water container with the neck portion thereof directed horizontally and formed in the shape of a box having handles is placed detachably on the container mounting table, as described above. Therefore, the raw water container can be set to the water dispenser by: removing the container holder from the container mounting table; stowing the raw water container inside the container holder by placing the container holder so as to cover the raw water container; and then by placing the container holder on the container mounting table by holding the handles provided on the container holder, with the raw water container received therein. Thus, it is not necessary to lift up the raw water container by itself, and the setting of the raw water container can be carried out with ease. In addition, since there is no need to provide a handle to the raw water container, the cost of the raw water container itself is not increased.

### BRIEF DESCRIPTION OF THE DRAWINGS

FIG. 1 is a sectional view of a water dispenser embodying the present invention, illustrating the state when it is in a normal operation mode.

FIG. 2 is an enlarged sectional view of the water dispenser shown in FIG. 1, showing the vicinity of a position at which a raw water container is set.

FIG. 3 is a sectional view of the water dispenser shown in FIG. 2, taken along the line

FIG. 4 is a sectional view of a main section of the water dispenser shown in FIG. 1, illustrating the state in which the container mounting table is pulled out of a housing.

FIG. 5 is an enlarged sectional view of the water dispenser shown in FIG. 2, showing the vicinity of a joint portion.

FIG. 6 is an enlarged sectional view of the water dispenser shown in FIG. 2, illustrating the state before the raw water container is connected to the joint portion.

FIG. 7 is a sectional view of the water dispenser shown in FIG. 1, illustrating the state when it is in a sterilization operation mode.

FIG. 8a to FIG. 8c are views of the water dispenser shown in FIG. 1, illustrating the process in which the raw water container is received in the container holder.

FIG. 9 is an enlarged sectional view of a conventional water dispenser, showing the vicinity of a position at which a raw water container is set.

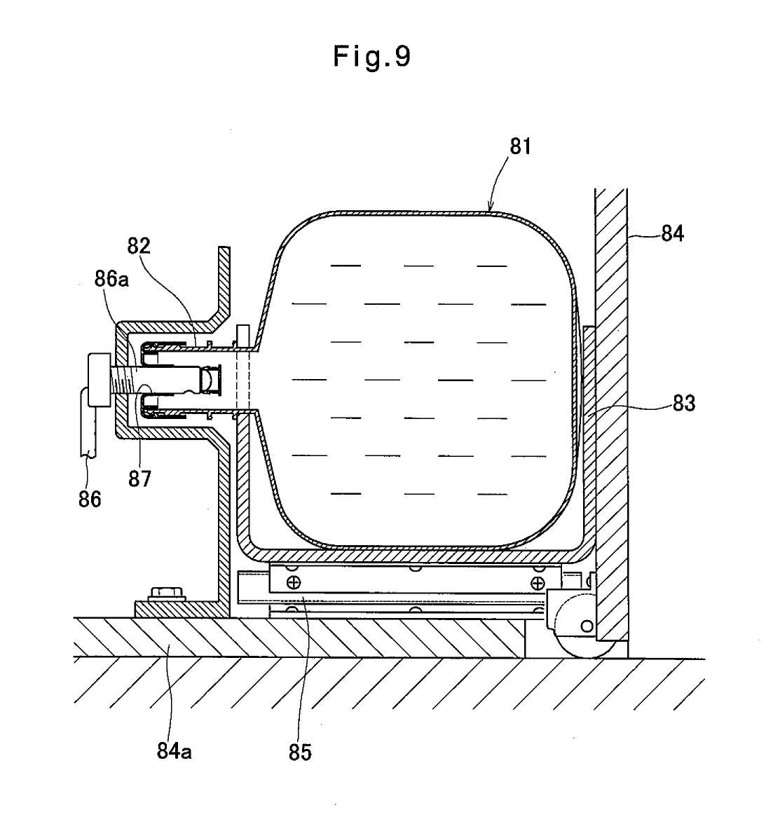

### MODE FOR CARRYING OUT THE INVENTION

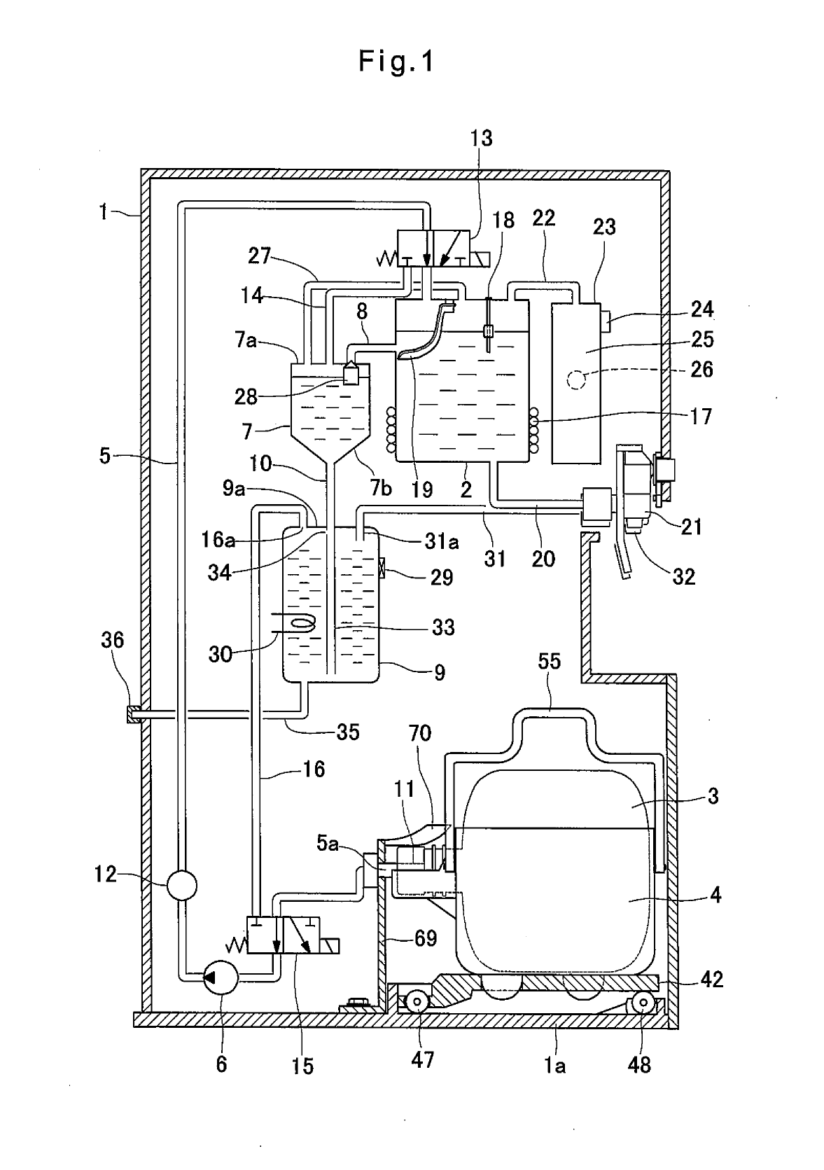

A water dispenser embodying the present invention is shown in FIG. 1. This water dispenser includes: a housing 1; a cold water tank 2 configured to store low temperature drinking water so that low temperature drinking water can be discharged to the outside of the housing 1, a replaceable raw water container 3 filled with drinking water to be supplied to the cold water tank 2; a container holder 4 configured to support the raw water container 3; a raw water pumping pipe 5 which allows communication between the raw water container 3 and the cold water tank 2; a pump 6 provided at an intermediate portion in the raw water pumping pipe 5; a buffer tank 7 provided laterally of the cold water tank 2; a buffer tank water supply pipe 8 configured to transfer drinking water in the cold water tank 2 into the buffer tank 7; a hot water tank 9 configured to store high temperature drinking water so that high temperature drinking water can be discharged to the outside of the housing 1; and a hot water tank water supply pipe 10 which allows communication between the buffer tank 7 and the hot water tank 9.

A joint portion 5a is provided at the end portion of the raw water pumping pipe 5 on the upstream side thereof, and configured to be detachably connected to a water outlet port 11 of the raw water container 3. The end portion of the raw water pumping pipe 5 on the downstream side thereof is connected to the cold water tank 2. The raw water pumping pipe 5 is formed so as to extend downward from the joint portion 5a, and then redirect upward, so that it passes through a position lower than the joint portion 5a. The pump 6 is provided in the raw water pumping pipe 5 at its portion lower than the joint portion 5a.

The pump 6 is configured to transfer drinking water in the raw water pumping pipe 5 from the side of the raw water container 3 toward the cold water tank 2, and to pump out drinking water from the raw water container 3 through the raw water pumping pipe 5. The pump 6 may be a diaphragm pump or a gear pump, for example.

A flow rate sensor 12 is provided in the raw water pumping pipe 5, at the discharge side of the pump 6. When the flow rate sensor 12 detects that drinking water is not flowing in the raw water pumping pipe 5 while the pump 6 is in operation, a container replacement-lamp placed on the front surface of the housing 1, which is not shown, is turned on, to notify a user that the raw water container 3 needs to be replaced.

A first three-way valve 13 is provided in the portion of the raw water pumping pipe 5 between the pump 6 and the cold water tank 2 (preferably, at the end portion of the raw water pumping pipe 5 on the side of the cold water tank 2). Although the figures show an example in which the first three-way valve 13 is disposed at a position away from the cold water tank 2, the first three-way valve 13 may be directly connected to the cold water tank 2. A first sterilization pipe 14 is connected to the first three-way valve 13 and configured to allow communication between the first three-way valve 13 and the buffer tank 7. The end portion of the first sterilization pipe 14 on the side of the buffer tank 7 is connected to an upper surface 7a of the buffer tank 7.

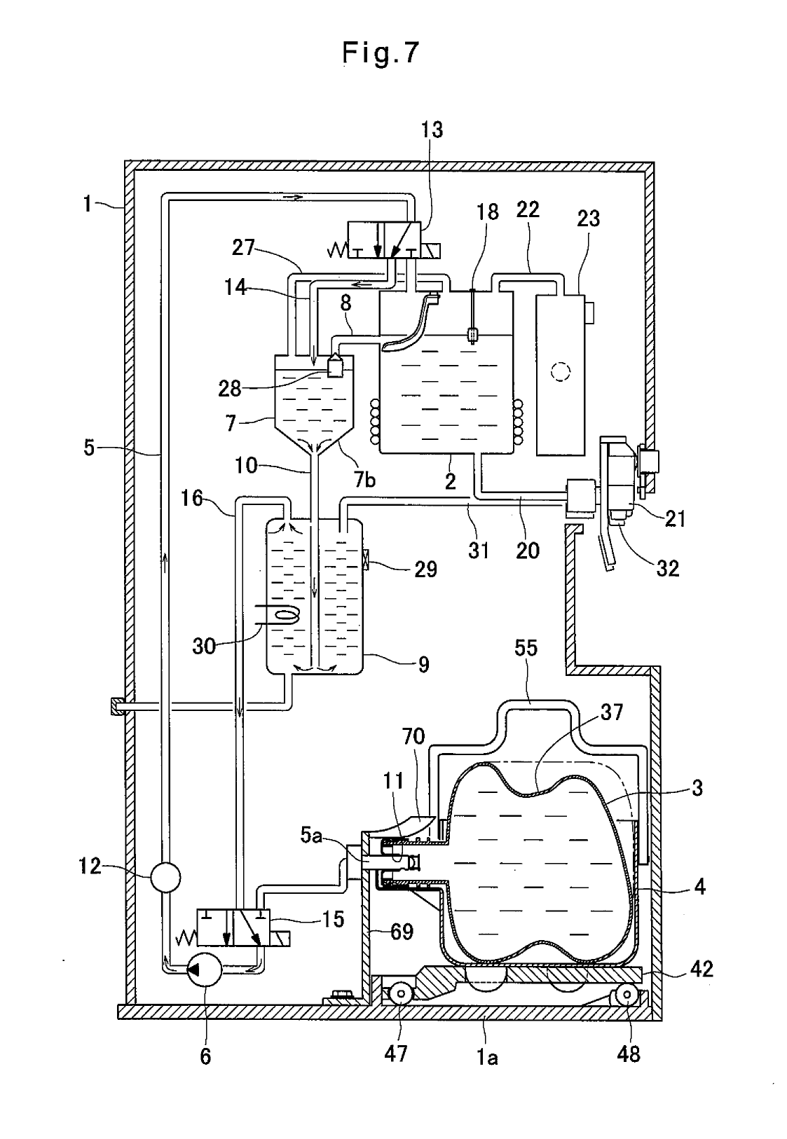

The first three-way valve 13 is configured to be capable of switching the flow of water between a first normal flow path (see FIG. 1) and a first sterilization flow path (see FIG. 7). When switched to form the first normal flow path, the first three-way valve 13 allows communication between the pump 6 and the cold water tank 2, while blocking communication between the pump 6 and the first sterilization pipe 14; and when switched to form the first sterilization flow path, the first three-way valve 13 blocks communication between the pump 6 and cold water tank 2, and allows communication between the pump 6 and the first sterilization pipe 14. In this embodiment, the first three-way valve 13 is a solenoid valve configured to switch the flow of water from the first normal flow path to the first sterilization flow path when energized, and from the first sterilization flow path to the first normal flow path when de-energized.

A second three-way valve 15 is provided in the portion of the raw water pumping pipe 5 between the pump 6 and raw water container 3 (preferably, at the end portion of the raw water pumping pipe 5 on the side of the raw water container 3). Although the figures show an example in which the second three-way valve 15 is disposed at a position away from the joint portion 5a, the second three-way valve 15 may be directly connected to the joint portion 5a. A second sterilization pipe 16 is connected to the second three-way valve 15 and configured to allow communication between the second three-way valve 15 and the hot water tank 9. The end portion of the second sterilization pipe 16 on the side of the hot water tank 9 is connected to an upper surface 9a of the hot water tank 9.

The second three-way valve 15 is configured to be capable of switching the flow of water between a second normal flow path (see FIG. 1) and a second sterilization flow path (see FIG. 7). When switched to form the second normal flow path, the second three-way valve 15 allows communication between the pump 6 and the raw water container 3, while blocking communication between the pump 6 and the second sterilization pipe 16; and when switched to form the second sterilization flow path, the second three-way valve 15 blocks communication between the pump 6 and the raw water container 3, and allows communication between the pump 6 and the second sterilization pipe 16. In this embodiment, the second three-way valve 15 is a solenoid valve, as with the first three-way valve 13, configured to switch the flow of water from the second normal flow path to the second sterilization flow path when energized, and from the second sterilization flow path to the second normal flow path when de-energized.

Each of the first three-way valve 16 and the second three-way valve 17 shown in the figures may be replaced by a three-way valve assembly comprising a plurality of two-way valves to achieve the same effect.

The cold water tank 2 contains air and drinking water in upper and lower layers. A cooling device 17 is attached to the cold water tank 2, and is configured to cool the drinking water contained in the cold water tank 2. The cooling device 17 is positioned at the lower outer periphery of the cold water tank 2, so that the drinking water inside the cold water tank 2 is maintained at a low temperature (about 5 degrees Celsius).

A water level sensor 18 is installed in the cold water tank 2 and configured to detect the water level of the drinking water accumulated in the cold water tank 2. When the water level detected by the water level sensor 18 falls to a predetermined level, the pump 6 is actuated to pump up drinking water from the raw water container 3 into the cold water tank 2.

A guide plate 19 is provided inside the cold water tank 2, and configured to redirect the flow of the drinking water flowing from the raw water pumping pipe 5 into the cold water tank 2 in the vertical direction to a horizontal direction, when drinking water is pumped up from the raw water container 3 into the cold water tank 2. The guide plate 19 prevents the low temperature drinking water accumulated in the lower portion of the cold water tank 2 from being stirred by the normal temperature drinking water flowing into the cold water tank 2 from the raw water pumping pipe 5.

A cold water discharging pipe 20 is connected to the bottom surface of the cold water tank 2 such that low temperature drinking water in the cold water tank 2 can be discharged to the outside of the housing 1 through the cold water discharging pipe 20. The cold water discharging pipe 20 is provided with a cold water cock 21 capable of being operated from outside the housing 1, and low temperature drinking water can be discharged from the cold water tank 2 into a cup or the like by opening the cold water cock 21. The capacity of the cold water tank 2 to contain drinking water is less than the capacity of the raw water container 3, and is about from 2 to 4 liters.

An air sterilization chamber 23 is connected to the cold water tank 2 through an air introduction passage 22. The air sterilization chamber 23 includes a hollow casing 25 provided with an air inlet port 24; and an ozone generator 26 provided within the casing 25. The ozone generator 26 may be, for example, a low-pressure mercury lamp or a silent discharge apparatus. The air sterilization chamber 23 is maintained in a state in which the casing 25 thereof is filled with ozone at all times, by energizing the ozone generator 26 at regular intervals to generate ozone.

When the water level in the cold water tank 2 falls, air is introduced into the cold water tank 2 through the air introduction passage 22, such that the pressure in the cold water tank 2 is maintained at atmospheric pressure. Since air introduced into the cold water tank 2 is sterilized with ozone by passing through the air sterilization chamber 23, the air inside the cold water tank 2 is maintained clean.

The buffer tank 7 contains air and drinking water in upper and lower layers. An air pipe 27 is connected to the upper surface 7a of the buffer tank 7. The air pipe 27 maintains the pressure inside the buffer tank 7 at atmospheric pressure by allowing communication between the air layer in the buffer tank 7 and the air layer in the cold water tank 2.

The buffer tank water supply pipe 8 allows communication between the air layer in the buffer tank 7 and the cold water tank 2. The end portion of the buffer tank water supply pipe 8 on the side of the cold water tank 2 opens to the upper layer portion of the drinking water contained in the cold water tank 2, such that the drinking water in the upper layer portion of the cold water tank 2 is introduced into the buffer tank water supply pipe 8. This allows the upper layer portion of the drinking water in the cold water tank 2 to be supplied into the buffer tank 7, and prevents the low temperature drinking water accumulated in the lower portion of the cold water tank 2 from flowing into the buffer tank 7. Thus, the drinking water in the cold water tank 2 can be effectively maintained at a low temperature.

The end portion of the buffer tank water supply pipe 8 on the side of the buffer tank 7 is connected to the upper surface 7a of the buffer tank 7. Further, a float valve 28 is provided at the end portion of the buffer tank water supply pipe 8 on the side of the buffer tank 7, and configured to open and close according to the water level in the buffer tank 7. The float valve 28 allows the flow of water through the buffer tank water supply pipe 8 when the water level in the buffer tank 7 falls below a predetermined level, and blocks the flow of water therethrough when the water level in the buffer tank 7 rises to a predetermined level.

The capacity of the buffer tank 7 to contain drinking water is less than the capacity of the hot water tank 9, and is about from 0.2 to 0.5 liters. A bottom surface 7b of the buffer tank 7 is formed in the shape of a cone with a slope sloping downward toward its center. The hot water tank water supply pipe 10 is connected to the center of the bottom surface 7b of the buffer tank 7. The hot water tank water supply pipe 10 is connected to the hot water tank 9 disposed below the buffer tank 7.

The hot water tank 9 is entirely filled with drinking water. The hot water tank 9 is provided with a temperature sensor 29 configured to detect the temperature of the drinking water in the hot water tank 9, and a heater 30 configured to heat the drinking water in the hot water tank 9. As the temperature detected by the temperature sensor 29 decreases and increases, the heater 30 is turned on and off so that the temperature of the drinking water in the hot water tank 9 can be maintained high (about 90 degrees Celsius). Although the figures show an example in which a sheathed heater is used as the heater 30, a band heater may be used instead.

A hot water discharging pipe 31 is connected to the upper surface 9a of the hot water tank 9 such that that high temperature drinking water accumulated in the upper portion of the hot water tank 9 can be discharged to the outside of the housing 1 through the hot water discharging pipe 31. The hot water discharging pipe 31 is provided with a hot water cock 32 capable of being operated from outside the housing 1, and high temperature drinking water can be discharged from the hot water tank 9 into a cup or the like by opening the hot water cock 32. When drinking water is discharged from the hot water tank 9, drinking water in the buffer tank 7 is introduced into the hot water tank 9 through the hot water tank water supply pipe 10, due to its own weight. Accordingly, the hot water tank 9 is maintained fully filled at all times. The capacity of the hot water tank 9 to contain drinking water is about from 1 to 2 liters.

The hot water tank water supply pipe 10 includes an in-tank pipe portion 33 extending downward from the upper surface 9a of the hot water tank 9 into the interior of the hot water tank 9. The in-tank pipe portion 33 has an open lower end near the bottom surface of the hot water tank 9. At the position close to the upper surface 9a of the hot water tank 9, the in-tank pipe portion 33 includes a small hole 34 for communicating the interior and the exterior of the in-tank pipe portion 33.

The end portion 31a of the hot water discharging pipe 31 on the side of the hot water tank 9 extends through the upper surface 9a of the hot water tank 9 into the hot water tank 9 downward, and opens inside the hot water tank 9 at a position spaced apart downward from the upper surface 9a of the hot water tank 9 (for example, at a position about from 5 to 15 mm below the upper surface 9a of the hot water tank 9). The small hole 34 provided in the in-tank pipe portion 33 of the hot water tank water supply pipe 10 opens in the hot water tank 9 at a position higher than the opening position of the end portion 31a of the hot water discharging pipe 31 on the side of the hot water tank 9. Further, the end portion 16a of the second sterilization pipe 16 on the side of the hot water tank 9 opens to the hot water tank 9 at a position higher than the small hole 34 provided in the in-tank pipe portion 33 of the hot water tank water supply pipe 10.

A drain pipe 35 is connected to the bottom surface of the hot water tank 9, and extends to the exterior of the housing 1. The outlet port of the drain pipe 35 is closed with a plug 36. However, an on-off valve may be provided instead of the plug 36.

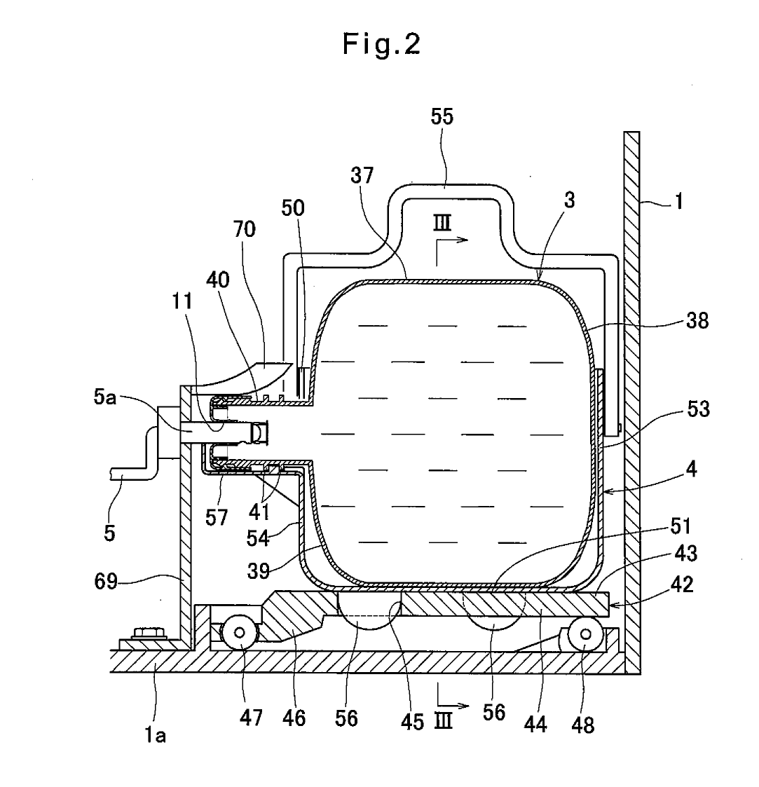

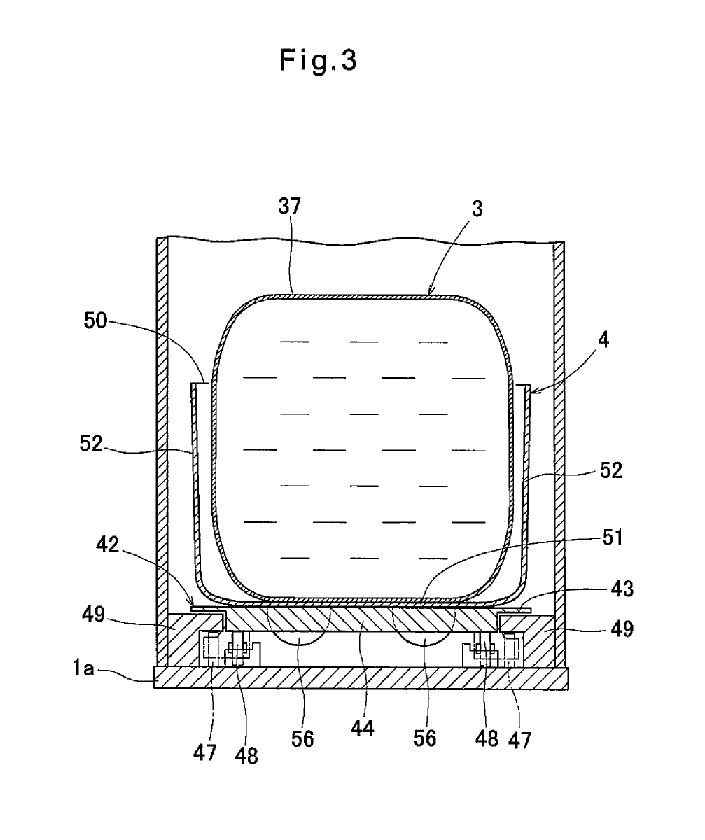

As shown in FIG. 2 and FIG. 3, the raw water container 3 includes a trunk portion 37 having a square-shaped cross section and formed in the shape of a hollow square tube; a bottom portion 38 provided at one end of the trunk portion 37; and a neck portion 40 provided on the other end of the trunk portion 37 through a shoulder portion 39, and including the water outlet port 11. A pair of flanges 41 are formed on the outer periphery of the neck portion 40. The trunk portion 37 is formed flexible so that the raw water container 3 collapses as the amount of water remaining therein decreases. The entire raw water container 3 is made by blow molding of polyethylene terephthalate (PET) resin. The capacity of the raw water container 3 is about from 10 to 20 liters when fully filled.

It is also possible to use a container which is formed rigid overall as the raw water container. However, it is preferred that the raw water container 3 be formed flexible so as to be collapsible as the amount of water remaining in the raw water container 3 decreases, as in this embodiment, so that drinking water in the raw water container 3 can be easily pumped out even when the water outlet port of the raw water container 3 is directed horizontally.

The raw water container 3 is placed on a container mounting table 42 while being received in the container holder 4.

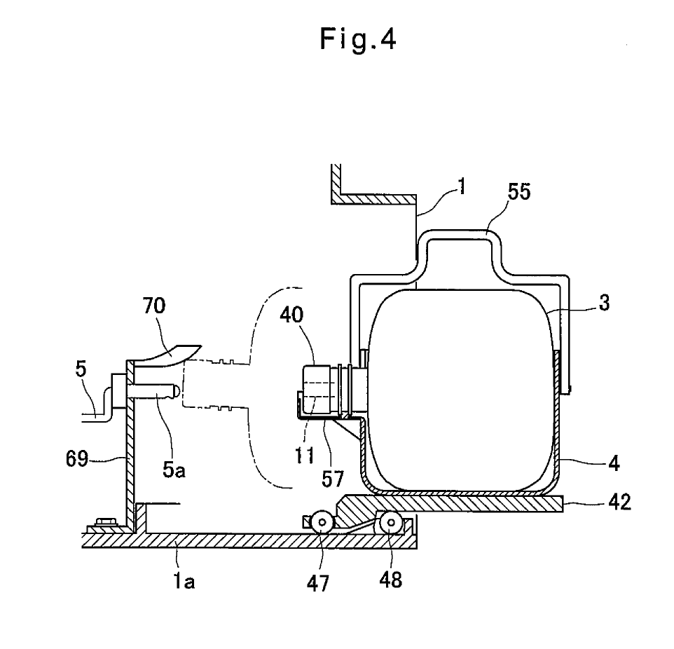

The container mounting table 42 includes a mounting portion 43 having the shape of a substantially rectangular plate; and a reinforcing portion 44 provided on the bottom side of the mounting portion 43. Three through holes 45 extend through the mounting portion 43 and the reinforcing portion 44, from the upper surface of the mounting portion 43 to the bottom surface of the reinforcing portion 44, and configured to serve as fitting portions for fixing the position of the container holder 4. Further, wheels 47 are attached to a right and left pair of wheel attaching portions 46 extending rearwardly from the rear end of the reinforcing portion 44, and configured to roll on a bottom plate 1a of the housing 1. As used herein, the words “forward” and “rearward” refer, respectively, to the directions toward and away from a user standing before the water dispenser. On the other hand, on the upper surface of the bottom plate 1a of the housing 1, there are provided a right and left pair of rollers 48 supporting the bottom surface of the reinforcing portion 44 of the container mounting table 42, and a right and left pair of guides 49 extending linearly in the forward and rearward direction and configured to guide the respective side surfaces of the reinforcing portion 44 of the container mounting table 42. This allows the container mounting table 42 to be horizontally movable, while being guided by the guides 49, between a set position (the position shown in FIG. 2) at which the raw water container 3 is set inside the housing 1 and a pulled out position (the position shown in FIG. 4) at which the raw water container 3 is pulled out of the housing 1.

The container holder 4 is detachably placed on the mounting portion 43 of the container mounting table 42 while holding the raw water container 3 with the water outlet port 11 thereof facing rearward.

The container holder 4 is formed in the shape of a box which opens upward to form an opening 50, through which the raw water container 3 can be placed into and taken out of the container holder 4. The container holder 4 includes: a supporting plate 51 for supporting the raw water container 3 from below; side plates 52 positioned on both sides of the raw water container 3; a front plate 53 positioned forward of the raw water container 3; a rear plate 54 positioned rearward of the raw water container 3; and a pair of handles 55 attached to the container holder 4 so as to bridge over the raw water container 3 in the forward and rearward direction. Each of the handles 55 has one end thereof pivotally attached to the front plate 53 and the other end pivotally attached to the rear plate 54.

The bottom surface of the supporting plate 51 of the container holder 4, that is, the surface which comes into contact with the container mounting table 42, is provided with three protruded portions 56 formed in the shape of a cone, each of which is configured to be fitted into each of the three through holes 45 provided at the container mounting table 42. With this arrangement, when the container holder 4 is placed on the container mounting table 42, the position of the container holder 4 relative to that of the container mounting table 42 can be fixed accurately and smoothly. The protruded portions 56 of the container holder may be formed in the shape of a hemisphere instead.

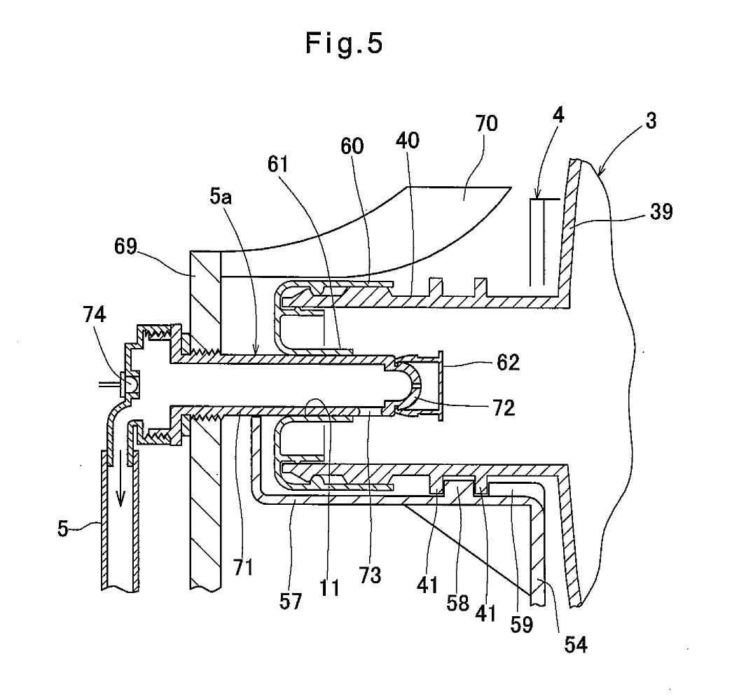

The rear plate 54 constitutes a portion of the peripheral wall of the container holder 4 and is provided with a neck supporting portion 57 extending from the outer surface of the rear plate 54 and configured to support the neck portion 40 of the raw water container 3. The neck supporting portion 57 is in the shape of a trough. whose upper surface is formed in a circular-arch shape having substantially the same radius of curvature as the radially outer surfaces of the flanges 41 formed on the neck portion 40 of the raw water container 3, and configured to be fitted to the lower portion of the neck portion 40 of the raw water container 3. As shown in FIG. 5, the upper surface of the neck supporting portion 57 is provided with a fan-shaped projecting piece 58 configured to be fitted between the pair of flanges 41 of the raw water container 3, and ribs 59 extending to the vicinity of the proximal end of the neck supporting portion 57, such that a space is defined between the projecting piece 58 and the ribs 59 on the proximal end side of the neck supporting portion 57. This space is of such a size that only one of the flanges 41 of the raw water container 3 can be inserted therein. With this arrangement, when the neck portion 40 of the raw water container 3 is fitted to the neck supporting portion 57, it is possible to prevent a situation in which both of the pair of flanges 41 of the raw water container 3 are fitted to the portion of the neck supporting portion 57 between the proximal end and the projecting piece 58.

Therefore, the position of the neck portion 40 of the raw water container 3 can be accurately fixed on the container holder 4 in the radial direction and the axial direction, by fitting the lower portion of the neck portion 40 (lower portion of the outer periphery of each of the flanges 41) of the raw water container 3 to the neck supporting portion 57, with the projecting piece 58 of the neck supporting portion 57 being fitted between the pair of flanges 41 of the raw water container 3. As a result, when the container mounting table 42 comes to the set position, the water outlet port 11 of the raw water container 3 can be reliably and securely connected to the joint portion 5a of the raw water pumping pipe 5.

Next, the structure which allows for the connection between the raw water container 3 and the joint portion 5a will be described.

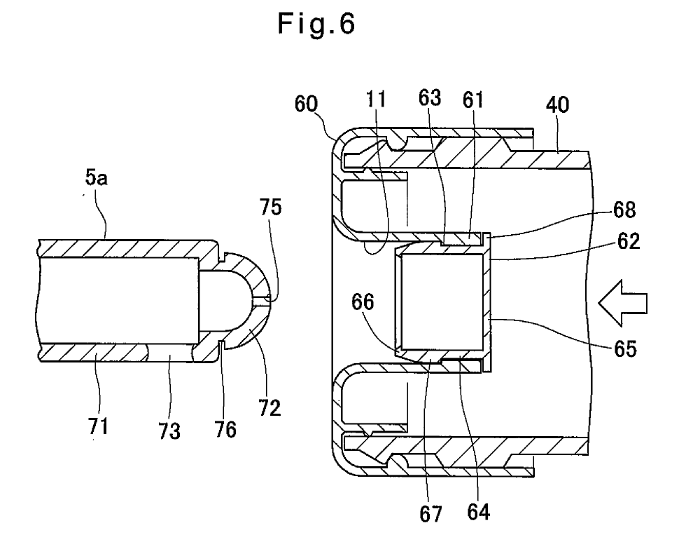

As shown in FIG. 5, a cap 60 is attached to the distal end of the neck portion 40 of the raw water container 3. An inner tube 61 is formed at the center of the cap 60. The inner tube 61 extends in parallel with the neck portion 40 toward the interior of the raw water container 3, and opens at its both ends. The inner space of the inner tube 61 forms the water outlet port 11 of the raw water container 3, and a plug body 62 is detachably fitted to the water outlet port 11, before the water outlet port 11 is connected to the joint portion 5a (see FIG. 6). The cap 60 is formed by injection molding of polyethylene (PE) resin.

As shown in FIG. 6, a stepped portion 63 is formed on the inner peripheral surface of the inner tube 61 of the raw water container 3 such that the inner peripheral surface of the inner tube 61 has a smaller diameter at is portion closer to the interior of the raw water container 3. The plug body 62 is a tubular member including a cylindrical portion 64, a closed bottom end portion 65 formed at one end of the cylindrical portion 64, and a claw portion 66 formed along the inner periphery of the other end of the cylindrical portion 64. The plug body 62 is fitted to the inner tube 61, with its opening facing toward the exterior of the raw water container 3. A projection 67 is formed on the outer peripheral surface of the cylindrical portion 64 of the plug body 62, and engages with the stepped portion 63 of the inner tube 61. An opposed piece 68 is formed at the end portion of the cylindrical portion 64 on the side of the interior of the raw water container 3 to face the end portion of the inner tube 61 in the axial direction.

On the other hand, the joint portion 5a is fixed in position inside the housing 1 such that the joint portion 5a is disconnected from the water outlet port 11 of the raw water container 3 when the container mounting table 42 has been moved to the pulled out position as shown in FIG. 4, and the joint portion 5a is connected to the water outlet port 11 of the raw water container 3 when the container mounting table 42 has been moved to the set position, as shown in FIG. 2.

As shown in FIG. 2, the joint portion 5a is fixed to, while extending through, a fixing plate 69 standing on the upper surface of the bottom plate 1a of the housing 1. A guide piece 70 is provided at the upper end of the fixing plate 69 and extends toward the raw water container 3. The guide piece 70 is a member formed in the shape of a square column having a rectangular cross section, and the distal end portion thereof curves upward as it gets closer to the raw water container 3. With this arrangement, even if, as shown by the chain line in FIG. 4, the neck portion 40 of the raw water container 3 is tilted such that the distal end of the neck portion 40 is not aligned with the joint portion 5a, when the raw water container 3 is set inside the housing 1, the guide piece 70 guides the neck portion 40 of the raw water container 3 toward the joint portion 5a.

As shown in FIG. 5, the joint portion 5a is formed in the shape of a cylinder extending horizontally and configured to be fitted to the water outlet port 11 of the raw water container 3. The joint portion 5a includes a straight portion 71 having a cylindrical outer peripheral surface, and a tip portion 72 formed in the shape of a hemisphere. The diameter of the straight portion 71 is determined such that the straight portion 71 can be fitted to the water outlet port 11 (in other words, the inner tube 61) of the raw water container 3 with an interference fit. The straight portion 71 is provided with a water flow hole 73 configured to open to the interior of the raw water container 3 when the joint portion 5a is fitted to the water outlet port 11 of the raw water container 3.

The water flow hole 73 is entirely provided only in the lower half portion of the joint portion 5a, and not in the upper half portion thereof. Therefore, it is possible to pump out the drinking water in the raw water container 3 as much as possible, even when the amount of drinking water left in the raw water container 3 is decreased. Further, when the raw water container 3 is disconnected from the joint portion 5a, air is less likely to enter the joint portion 5a through the water flow hole 73, and the drinking water in the joint portion 5a can be prevented from flowing out therethrough.

An ultraviolet light emitting device 74 is provided at the base of the joint portion 5a. The ultraviolet light emitting device 74 irradiates ultraviolet rays to the drinking water inside the joint portion 5a and to the inner surface of the joint portion 5a to carry out sterilization. An ultraviolet LED or a mercury lamp can be used as the ultraviolet light emitting device 74.

As shown in FIG. 6, an air flow hole 75 is formed through the center of the tip portion 72 of the joint portion 5a to communicate with the interior and the exterior of the joint portion 5a. Further, a circumferential groove 76 is formed on the outer periphery of the joint portion 5a at the boundary between the straight portion 71 and the tip portion 72, such that the claw portion 66 of the plug body 62 is engageable in the circumferential groove 76.

To connect the raw water container 3 to the joint portion 5a, the raw water container 3 is moved horizontally toward the joint portion 5a, from the position shown in FIG. 6. When the raw water container 3 is moved as described above, the tip portion 72 of the joint portion 5a is first inserted into the plug body 62 of the raw water container 3, and the claw portion 66 of the plug body 62 is engaged with the circumferential groove 76 of the joint portion 5a. At this time, since air in the space defined between the plug body 62 and the tip portion 72 of the joint portion 5a escapes into the interior of the joint portion 5a through the air flow hole 75 of the joint portion 5a, the plug body 62 can be smoothly fitted to the tip portion 72 of the joint portion 5a.

As the raw water container 3 is pushed further, the projection 67 of the plug body 62 is disengaged from the stepped portion 63 of the inner tube 61, while leaving the plug body 62 engaged with the joint portion 5a, and the water flow hole 73 of the joint portion 5a opens to the interior of the raw water container 3, as shown in FIG. 5, thereby completing the connection.

It is now described how the above described water dispenser is operated.

When the water dispenser is in the normal operation mode, a water level control which maintains the water level in the cold water tank 2 within a certain range, and a heater control which maintains the drinking water in the hot water tank 9 at a high temperature are carried out, with the first three-way valve 13 and the second three-way valve 15 switched to form the normal flow path, as shown in FIG. 1.

When a user operates the cold water cock 21 at this time, low temperature drinking water in the cold water tank 2 is discharged to the outside of the housing 1 through the cold water discharging pipe 20, due to its own weight, and the drinking water in the cold water tank 2 is decreased. When the water level in the cold water tank 2 detected by the water level sensor 18 falls below a predetermined lower limit, the pump 6 is actuated by the above described water level control, and drinking water in the raw water container 3 is pumped up to the cold water tank 2 through the raw water pumping pipe 5.

When a user operates the hot water cock 32, high temperature drinking water in the hot water tank 9 is discharged to the outside of the housing 1 through the hot water discharging pipe 31, and drinking water in the buffer tank 7 is transferred to the hot water tank 9 through the hot water tank water supply pipe 10, due to its own weight. At this time, the drinking water in the buffer tank 7 plays a role to push out the drinking water in the hot water tank 9 to the outside. When drinking water in the buffer tank 7 is introduced into the hot water tank 9, the water level in the buffer tank 7 falls, which causes the float valve 28 to move away from its position blocking the end of the buffer tank water supply pipe 8, thereby allowing for the transfer of drinking water in the upper layer portion of the cold water tank 2 into the buffer tank 7 through the buffer tank water supply pipe 8.

When drinking water is transferred from the buffer tank 7 into the hot water tank 9, the temperature of the drinking water in the hot water tank 9 is decreased. When the temperature of the drinking water in the hot water tank 9 detected by the temperature sensor 29 falls below a predetermined lower limit determined by the heater control (for example, 85 degrees Celsius), the heater 30 is turned on to heat the drinking water in the hot water tank 9.

On the other hand, when the water dispenser is in the sterilization operation mode, as shown in FIG. 7, the above described water level control is terminated, and a water circulation control, in which the pump 6 is actuated with the first three-way valve 13 and the second three-way valve 15 switched to form the sterilization flow path, and the above mentioned heater control are carried out simultaneously. This allows the high temperature drinking water in the hot water tank 9 to be circulated through: the second sterilization pipe 16, the second three-way valve 15, the raw water pumping pipe 5, the first three-way valve 13, the first sterilization pipe 14, the buffer tank 7, and the hot water tank water supply pipe 10, in this order, and thus, the pipes, valves and tanks through which hot water is circulated can be sterilized.

Since the high temperature drinking water does not pass through the cold water tank 2 at this time, it is possible for the user to discharge low temperature drinking water in the cold water tank 2, even when the water dispenser is in the sterilization operation mode.

In the normal operation mode, drinking water in the raw water container 3 is decreased as drinking water in the cold water tank 2 or the hot water tank 9 is discharged. When the raw water container 3 becomes empty, the flow of the drinking water in the raw water pumping pipe 5 stops even while the pump 6 is in operation. The flow rate sensor 12 detects this fact and the container replacement-lamp is turned on.

When the container replacement-lamp is turned on, the user carries out the replacement of the raw water container 3 as follows. First, the container mounting table 42 is pulled out from the housing 1, as shown in FIG. 4. At this time, since the container holder 4 and the raw water container 3 moves together with the container mounting table 42, the raw water container 3 is disconnected from the joint portion 5a fixed inside the housing 1. The container holder 4 is then removed from the container mounting table 42, and the raw water container 3, which is now empty, is taken out of the container holder 4.

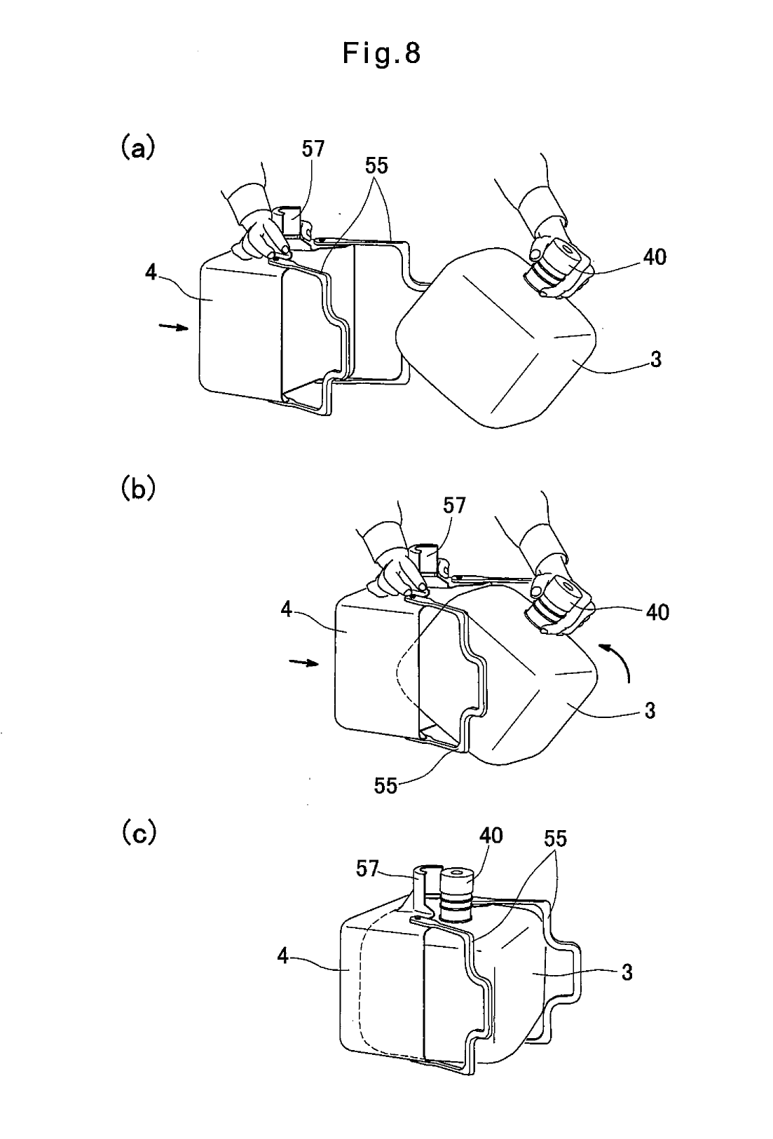

Next, a fully filled raw water container 3 is placed on the floor, close to the position at which the water dispenser is disposed, with the neck portion 40 of the raw water container 3 facing vertically upward. In this state, as shown in FIG. 8(a), with the raw water container 3 held in a tilted position, the container holder 4 is slid toward the raw water container 3 with its opening facing sideways so as to cover the raw water container 3. Then as shown in FIG. 8(b), the container holder 4 is further slid while pivoting the raw water container 3 back into the original upright position, to achieve a state in which the raw water container 3 is substantially completely received in the container holder 4, as shown in FIG. 8(c). Then, with the raw water container 3 received in the container holder 4, the container holder 4 is turned to a position lying on its side, and placed on the container mounting table 42 by holding the handles 55 of the container holder 4. At this time, the neck portion 40 of the raw water container 3 is fitted to the neck supporting portion 57 of the container holder 4.

Finally, the container mounting table 42 is pushed back to be stowed inside the housing 1 together with the container holder 4 and the raw water container 3, and at the same time, the raw water container 3 is connected to the joint portion 5a fixed inside the housing 1, thereby completing the replacement of the raw water container 3.

As described above, when the replacement of the raw water container 3 is carried out in this water dispenser, the raw water container 3 can be stowed in the container holder 4, with the container holder 4 removed from the container mounting table 42, and then the container holder 4 can be placed on the container mounting table 42 with the raw water container 3 received therein by holding the handles 55 of the container holder 4. Therefore, it is not necessary to lift up the raw water container 3 alone, and the raw water container 3 can be set to the water dispenser easily in a position lying on its side. Further, since there is no need to provide a handle to the raw water container 3, the cost of the raw water container 3 itself is not increased.

In addition, when the container holder 4 is placed on the container mounting table 42, the position of the container holder 4 on the container mounting table 42 can be fixed accurately and smoothly, and at the same time, the position of the neck portion 40 of the raw water container 3 relative to that of the container holder 4 can be fixed accurately in the radial direction and in the axial direction. Therefore, when the container mounting table 42 is stowed in the housing 1 to be set to the set position, the water outlet port 11 of the raw water container 3 can be securely connected to the joint portion 5a of the raw water pumping pipe 5. Accordingly, the connection between the raw water container 3 and the raw water pumping pipe 5 can be achieved easily. This also serves to improve the operational efficiency in the replacement of the raw water container 3.

In addition, even in cases where the raw water container 3 received in the container holder 4 is damaged, when canying out the replacement of the raw water container 3, to result in a leaking of drinking water therefrom, it is possible to remove the container holder 4 from the container mounting table 42 to dispose of the drinking water accumulated inside the container holder 4. Therefore, it requires much less workload to resume the replacement of the raw water container 3, compared to that in the conventional water dispenser, in which the container holder is fixed and the leaked drinking water needs to be pumped out from the container holder.

Although the flanges 41 are formed on the neck portion 40 of the raw water container 3 in the above mentioned embodiment, the flanges may be formed on the cap attached to the neck portion of the raw water container 3. Further, an embodiment is also possible in which the flanges are not provided on the neck portion of the raw water container, and the container holder is provided with a clamping means configured to hold the neck portion, so that the clamping means restricts the movement of the water outlet port of the raw water container.

In this embodiment, three protruded portions are provided on the bottom surface of the supporting plate of the container holder, and three fitting portions, such as through holes, into which the protruded portions are fitted, are provided at the container mounting table. It is preferred that three or more of, and the same number of, the protruded portions and the fitting portions be provided. If three or more of the protruded portions are provided, the protruded portions facilitate the stabilization of the position of the container holder, when the container holder is removed from the container mounting table and placed on the floor surface or the like, serving as feet to support the container holder. Further, contrary to this embodiment, it is also possible to provide protruded portions on the upper surface of the container mounting table, and to provide fitting portions into which the protruded portions are fitted on the supporting plate of the container holder. In this case, the thickness of the supporting plate of the container holder is preferably increased, so that the fitting portions do not affect the raw water container received in the container holder.

### DESCRIPTION OF SYMBOLS

3 raw water container
4 container holder
5 raw water pumping pipe
11 water outlet port
40 neck portion
41 flange
42 container mounting table
45 through hole (fitting portion)
50 opening
55 handle
56 protruded portion
57 neck supporting portion
58 projecting piece
59 rib

1. A water dispenser comprising:
a replaceable raw water container comprising: a hollow cylindrical trunk portion; a bottom portion provided at one end of the trunk portion; and a neck portion provided at another end of the trunk portion through a shoulder portion; wherein the neck portion is provided with a water outlet port;
a container mounting table configured such that the raw water container can be placed on the container mounting table; and
a raw water pumping pipe configured to be connected to the water outlet port of the raw water container;
wherein a container holder which is formed in a shape of a box having a handle and configured to hold the raw water container with the neck portion thereof directed horizontally is placed detachably on the container mounting table.

2. The water dispenser according to claim 1, wherein the container holder opens upward to form an opening configured such that the raw water container can be placed into and taken out of the container holder through the opening.

3. The water dispenser according to claim 1, wherein a plurality of protruded portions are provided on a surface of the container holder which comes into contact with the container mounting table, and wherein the container mounting table is provided with fitting portions into which the protruded portions are inserted.

4. The water dispenser according to claim 3, wherein the protruded portions of the container holder are conical or hemispheric in shape.

5. The water dispenser according to claim 1, wherein a neck supporting portion configured to support the neck portion of the raw water container is provided at a peripheral wall of the container holder.

6. The water dispenser according to claim 5, wherein the neck supporting portion of the container holder is formed in the shape of a trough protruding outwardly from the peripheral wall of the container holder and configured to be fitted to a lower side of the neck portion of the raw water container.

7. The water dispenser according to claim 6, wherein a pair of flanges are provided on an outer periphery of the neck portion of the raw water container, and a projecting piece configured to engage with the pair of flanges are provided on an upper surface of the neck supporting portion of the container holder.

8. The water dispenser according to claim 7, wherein a rib is provided on the upper surface of the neck supporting portion of the container holder on a side of a proximal end of the neck supporting portion to extend to a vicinity of the proximal end, such that a space is defined between the rib and the projecting piece, wherein the space is arranged such that only one of the flanges of the raw water container can be inserted into the space.
